(19) United States
(12) Patent Application Publication
(10) Pub. No.: US 2010/0197432 A1
(43) Pub. Date: Aug. 5, 2010

(54) TENSIONING DEVICE FOR TRACTION MECHANISM DRIVES

(75) Inventors: Niels Flaemig, Hessdorf (DE); Roland Arneth, Eggolsheim (DE); Bernd Hartmann, Weisendorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/667,571

(22) PCT Filed: Jun. 13, 2008
(86) PCT No.: PCT/EP08/57493

§ 371 Date: Jan. 4, 2010

(30) Foreign Application Priority Data
Jul. 5, 2007 (DE) 10 2007 031 294.8

(51) Int. Cl. F16H 7/10

(52) U.S. Cl. 474/117

(57) ABSTRACT

The invention relates to a tensioning device (1) of a traction mechanism drive, comprising a base part (2) and a pivot arm (9), between which base part (2) and pivot arm (9) is inserted a torsional spring (17) which exerts both a torque on the pivot arm (9) and also a spreading force between the base part (2) and the pivot arm (9). To axially secure the pivot arm (9) to the base part (2), a latching connector (10) is provided which has a perforated disc (11) which is supported on a bearing pin (3) of the base part (2) and which extends radially into a region of the hub (8) of the pivot arm (9). An axially projecting extension (12) of the latching connector (10) engages into a receptacle (5), which is designed as a stepped bore (4), of the bearing pin (3), wherein an end region (14) is supported, in a radially flared fashion, on a step (15) of the receptacle (5).

### FIELD OF THE INVENTION

The present invention relates to a tensioning device for traction mechanism drives, which substantially comprises a base part and a pivot arm, between which a torsion spring is inserted, which exerts a torque directed in the tensioning direction of the pivot arm and which generates an expansion force between the pivot arm and the base part. The tensioning device furthermore includes a damping device, which includes a friction element inserted between a torsionally rigid and pivotal component of the tensioning device. The pivot bearing incorporated in the tensioning device comprises a bolt, which is torsionally rigidly connected to the base part and on which the pivot arm is rotatably supported by way of a hub, these components being captively joined together by means of a locking device. With the tensioning device in the fitted state, a tensioning pulley rotatably positioned at the free end of the pivot arm is supported against a traction mechanism of the traction mechanism drive.

### BACKGROUND OF THE INVENTION

Traction mechanism drives, in particular belt drives on internal combustion engines, are used to drive units such as, in particular, alternators, fans or water pumps. A constant tensioning of the traction mechanism is necessary for a secure, virtually slip-free drive. One known measure for ensuring that a set tensioning of the traction mechanism is maintained for as long as possible is to use automatically acting tensioning devices. Such mechanically or hydraulically acting tensioning devices are known in many different embodiments.

In one common type of mechanical tensioning device a tensioning arm supported in slide bearings and capable of pivoting in relation to a base part is provided with a tensioning pulley, which in the operating state is resiliently biased against the traction means. In order to afford a spring-loaded bracing support for the tensioning arm, use is made of a torsion spring, the first spring end of which is positioned on the base part and the second spring end of which is positioned on the pivotal tensioning arm, thereby imparting a torque to the tensioning arm. The pivot arm or tensioning arm transmits a tension set during assembly via the associated tensioning pulley to the traction mechanism and maintains the tension while the device is in the operating state. In contrast to manual tensioning devices there is no need for readjustment of the pivot arm. Instead, in order to produce a continuous tensioning of the traction mechanism, the torsion spring exerts on the pivot arm a torsional moment that is self-regulating through pivoting movements or the pivoting position of the tensioning arm.

For configuration of the pivot bearing of such tensioning devices in conjunction with an effective locking device between the pivot arm and the base part, EP 0 976 412 B1 discloses a tensioning device, in which a separate bearing journal is screwed into the base part. A slide bearing, which in the fitted state is inserted into a hub bore of the pivot arm and which allows rotation of the pivot arm, is positioned on the forward area of the journal protruding from the base part. A thread of the bolt provided at the end serves to receive a lock nut, which in conjunction with a thrust washer and a friction ring forms an axial stop for the pivot arm, which, owing to the axial force component of the torsion spring, is displaced in the direction of the lock nut. Besides a relatively large component size, this construction involves a greater production effort in order to avoid a disadvantageous misalignment with the base part over the entire pivoting range of the tensioning pulley in conjunction with the pivot arm.

### OBJECT OF THE INVENTION

The object of the invention is to provide a support for the pivot arm of the tensioning device which is cost-effective to produce, while effectively securing the pivot arm in relation to the base part.

### SUMMARY OF THE INVENTION

This object is achieved in that a latching connector is provided for the mutual securing of the pivot arm and the base part in relation to one another. This component of largely T-shaped design comprises a perforated disk, which forms a disk-like rim and which in the fitted state is supported on the hub of the pivot arm. A unilaterally protruding projection of the latching connector, of tubular design and integrally formed with the perforated disk, engages in a socket of the bearing bolt integrally connected to the base part. In order to effectively fasten the base part and pivot arm components together, the latching connector is fixed in position in the socket of the bearing bolt by force-fit and/or positive interlock. The construction according to the invention effectively and permanently fastens the pivot lever and the slide bearing on the bearing bolt of the base part. The latching connector according to the invention advantageously requires no separate or additional means and, once assembled, affords an effective, durable fastening.

Advantageous developments of the invention form the subject of the dependent claims 2-10.

In a preferred development of the tensioning device according to the invention, the latching connector is designed at its end in such a way that the latching connector in the fitted state is provided by means of a circumferential or at least in part radially outwardly directed flange, which in the fitted state has a radial overlap with a section of the socket of the bearing bolt. One feasible way of producing the flange, after fitting the pivot arm on the bearing bolt and fitting the latching connector, is to expand the end area of the latching connector by means of a tapered mandrel.

Other possible ways of producing a fixed attachment of the latching connector are wobble riveting and taper caulking. This riveting, which is comparable to flanging, also produces a circumferential or in part outwardly directed projection of the latching connector, in order to obtain a radial overlap with the socket of the bearing bolt.

For fixing the latching connector in position by wobble riveting or taper caulking the socket of the bearing bolt is preferably provided with a tapered face at the end. Due to the wobble riveting this results in a larger contact area between the end zone of the latching connector and the support face in the area of the socket, which has an advantageous effect on the quality of the positional fixing of the latching connector.

A further advantageous development of the bearing bolt provides for a socket in the form of a stepped bore. The stepped area is preferably located in the area of an end zone of the latching connector, so that the flanged zone or the end area of the latching connector intended for the wobble riveting is supported against the stepped section of the socket. To produce the stepped bore, the bearing bolt has a through-bore. Alternatively, a stepped bore may be provided in the form of a blind hole bore. In a further preferred design feature of the invention the latching connector is provided, at least at the end, with circumferentially distributed longitudinal slots, in order to form elastic tongues, which include lugs pointing radially outwards. The tongues are arranged and configured so that in the fitted state the tongues automatically snap onto an undercut, a groove or a step of the bore of the bearing bolt, forming a positive interlock. For this purpose the tongues are advantageously expanded outwards to a limited degree, so as to produce, in the fitted state, an effective, secure positional fixing of the latching connector. As a measure designed to improve and facilitate the fitting of the latching connector into the bore of the bearing journal, the lugs are provided with a circumferential fitting bevel directed towards the free end.

To support an axial force component of the torsion spring, the construction of the device according to the invention provides for a friction element, which includes a disk-shaped rim and which is located between a hub of the pivot arm and the perforated disk of the latching connector. The friction element forming an axial bearing is integrally connected to the slide bearing in order to create one basic unit. In the fitted state, the rim of the friction disk is positioned between the perforated disk of the latching connector and the hub of the pivot arm.

A preferred development of the axial bearing provides for sealing of an annular gap occurring between the perforated disk of the latching connector and the hub of the pivot arm. A sealing lip, for example, which is affixed to the rim of the friction element on the outside and which in the fitted state is supported by force-fit against the hub of the pivot arm and/or the disk-like rim of the latching connector, is suitable for this purpose.

In order to avoid disadvantageous tolerance fields in the fitted state, the pivot arm, base part and latching connector components are manufactured from a consistent material.

### BRIEF DESCRIPTION OF THE DRAWINGS

Exemplary embodiments of the invention are represented in the figures, which are described in more detail below and of which:

FIG. 1 shows a longitudinal section through a tensioning device, in which for positional fixing the latching connector is fixed in position by means of a flange;

FIG. 2 shows a tensioning device largely corresponding to FIG. 1, in which the latching connector is instead fixed by way of tongues, which latch against a projection of a stepped bore.

### DETAILED DESCRIPTION OF THE DRAWINGS

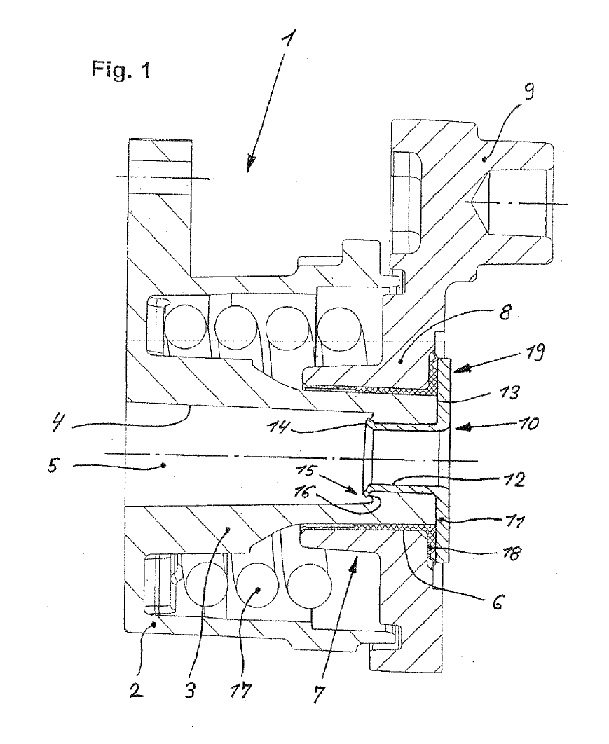

The tensioning device 1 represented in FIG. 1 is releasably fastened by way of a base part to a housing not represented in FIG. 1, in particular the crankcase of an internal combustion engine. The base part 2 of approximately pot-shaped design concentrically forms an axially projecting bearing bolt 3, which encloses a concentric socket 5 in the form of a stepped bore 4. A free end of the bearing bolt 3 serves to receive a slide bearing 6, which for the formation of a pivot bearing 7 is enclosed by a hub 8, which is integrally connected to a pivot arm 9. A free end of the eccentrically arranged pivot arm 9 serves to accommodate a tensioning pulley, not shown in FIG. 1. In order to fasten or fix the pivot arm 9 effectively to the bearing bolt 3 of the base part 2, a latching connector 10 is provided, comprising a perforated disk 11, joined to which on one side is an axially protruding projection 12. The perforated plate 11, which in the fitted state is supported against an end face 13 of the bearing bolt 3, extends radially into an area of the hub 8 of the pivot arm 9. The cylindrical projection 12 of the latching connector 10 is guided in the stepped bore 4 of the socket 5, an end area 14 of the projection 12 latching on a step 15 of the socket 5 inserted into the bearing bolt 3. The end area 14 is here preferably flanged radially outwards or is deformed by means of wobble riveting. In order to obtain a larger contact face or support face of the end area 14, the step 15 is designed as a tapering face 16. A torsion spring 17, the spring ends of which are fixed to the base part 2 on the one hand and to the pivot arm 9 on the other, is inserted between the base part 2 and the pivot arm 9. The torsion spring 17 exerts a torque on the pivot arm 19, so that this is braced under force-fit against the traction mechanism by way of the tensioning pulley. The torsion spring 17 furthermore exerts a expansion force acting between the base part 2 and the pivot arm 9, with the result that the hub 8 of the pivot arm 9 is supported against the perforated disk 11 of the latching connector 10 by way of a friction element 18. The friction element 18, assisted by the axial force of the torsion spring 17, also assumes the function of a damping device 19, which serves effectively to damp the adjusting movements of the pivot arm 9.

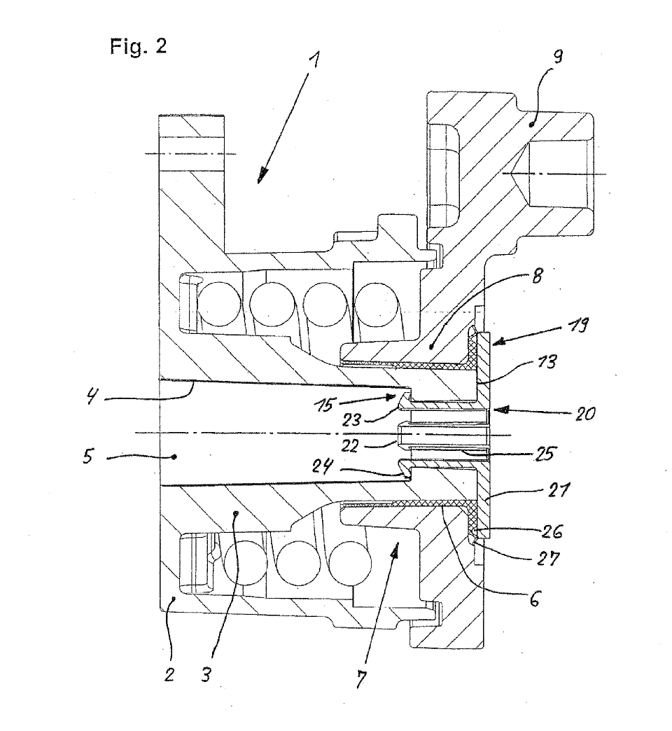

FIG. 2 shows the tensioning device 1 with a latching connector 20 of alternative design. All other components of the tensioning device 1 correspond to the tensioning device depicted in FIG. 1. The latching connector 20 includes a perforated disk 21, which includes axially projecting tongues 22 on one side. The tongues 22, arranged symmetrically distributed around the circumference of the concentric aperture of the perforated disk 21, extend over the longitudinal extent of the step 15 in the socket 5 of the bearing bolt 3. For secure fastening and positional fixing, the tongues 22 at the end have radially outwardly pointing lugs 23 locking against the step 15. All tongues 22 of the latching connector 20 are pretensioned radially outwards to a limited degree, in order thereby to ensure a secure force-closure locking of the lugs 23 against the step 15 in the fitted position. As an aid to fitting the latching connector 20, the lugs 23 are provided at the outer circumference with an end-face fitting bevel 24, which facilitates the introduction of the tongues 22 into the socket 5. Also incorporated in the socket 5, in the area of the stepped bore 4, are longitudinal slots 25 for positively interlocking reception of the tongues 22 of the latching connector 20. This ensures an effective torsional fixing of the latching connector 20 in relation to the bearing bolt 3 and hence the base part 2. A seal 27 is provided for sealing an annular gap 26 occurring between the perforated disk 21 of the latching connector 20 and the hub 8 of the pivot arm 9. According to FIG. 2, a seal 27 is provided in the form of a sealing lip, which is connected to the friction element 18 and which in the fitted position is braced by force-fit both against the external contour of the perforated disk 21 and against the hub 8. The seal 27 is thereby part of the slide bearing 6, embodied as a multifunctional part, to which the friction element 18 in the form of a rim is also assigned.

### LIST OF REFERENCE NUMERALS

1 tensioning device
2 base part
3 bearing bolt
4 stepped bore
5 socket
6 slide bearing
7 pivot bearing
8 hub
9 pivot arm
10 latching connector
11 perforated disk
12 projection
13 end face
14 end area
15 step
16 tapered face
17 torsion spring
18 friction element
19 damping device
20 latching connector
21 perforated disk
22 tongue
23 lug
24 fitting bevel
25 longitudinal slot
26 annular gap
27 seal

1. A tensioning device of a traction mechanism drive, comprising:
a base part;
a pivot arm;
a torsion spring, which is inserted between the pivot arm and the base part, and which exerts a torque directed in a tensioning direction of the pivot arm, and which generates an expanding force between the base part and the pivot arm;
a damping device, in which a friction element is inserted between a torsionally rigid component and a pivotal component;
a pivot bearing, comprising a bearing bolt, which is torsionally rigidly connected to the base part and on which the pivot arm is rotatably supported by way of a slide bearing;
a locking device joining the base part and the pivot arm together; and
a tensioning pulley rotatably arranged at an end of the pivot arm and interacting with a traction mechanism,
wherein for mutually securing the base part and the pivot arm components, a provision is made for a latching connector, which at an end is supported against the pivot arm by a perforated disk and a tubular, axially protruding projection or axially projecting tongues of which is/are fixed in position by force-fit and/or positively interlocking engagement in a socket of the bearing bolt.

2. The tensioning device of claim 1, wherein the latching connector in a fitted state is, to a limited extent, radially overlapped by an outwardly directed flange of an end area of a step of the socket, which flange is, at its end side, arranged circumferentially or partially.

3. The tensioning device of claim 1, wherein, in a fitted state, the projection of the latching connector is fixed at an end by means of a circumferential or partial wobble riveting or taper caulking of an end area, which to a limited extent radially overlaps a step of the socket.

4. The tensioning device of claim 3, wherein the end area of the latching connector formed by means of the wobble riveting is supported against the socket in the form of a tapered face.

5. The tensioning device of claim 4, wherein the flange or the wobble riveting interacts with a stepped bore or the socket of the bearing bolt embodied as a blind hole bore.

6. The tensioning device of claim 1, wherein the projection of the latching connector which is provided, at least at the end, with slots, includes elastic tongues, having lugs pointing radially outwards and in a fitted state engaging by force-fit and/or positive interlock in an undercut or a groove or interacting with a step.

7. The tensioning device of claim 1, wherein, for bracing an axial force of the torsion spring, a friction element is provided, which is located between a hub of the pivot arm and the perforated disk of the latching connector, the friction element being integrally connected to the slide bearing in order to form a basic unit.

8. The tensioning device of claim 7, wherein a seal is fitted for sealing an annular gap occurring between the perforated disk of the latching connector and the hub of the pivot arm.

9. The tensioning device of claim 8, wherein the friction element includes an external sealing lip, which, in a fitted, position is supported on the perforated disk and the hub, in order to create a seal.

10. The tensioning device of claim 1, wherein the base part, pivot arm and latching connector components are manufactured from a consistent material.
